(19) United States
(12) Patent Application Publication
(10) Pub. No.: US 2026/0252629 A1
(43) Pub. Date: Aug. 27, 2026

(54) EFFICIENT DATA EXPLORATION FOR SEARCH REQUESTS

(71) Applicant: AMADEUS S.A.S., Biot (FR)

(72) Inventors: Nicolas Stephen Didier HAUVILLER, Valbonne (FR); Eoin THOMAS, Antibes (FR); Ilias DRIOUICH, Nice (FR); Hongliu CAO, Nice (FR); Salma ABDOU, Nice (FR)

(21) Appl. No.: 19/334,766

(22) Filed: Sep. 19, 2025

(30) Foreign Application Priority Data
Feb. 25, 2025 (EP) 25305244.3

(51) Int. Cl. G06F 16/903; G06F 16/9035; G06F 16/9038

(52) U.S. Cl. CPC G06F 16/90335; G06F 16/9035; G06F 16/9038

(57) ABSTRACT

Computer-implemented method for processing data requests is presented. The method comprises receiving a first request defining a first set of search parameters, predicting search results to requests for different sets of search parameters, determining one or more sets of search parameters from the different sets of search parameters, transmitting a first response comprising at least a part of the one or more determined sets of search parameters with one or more associated predicted search results, receiving a selection of a second set of search parameters, retrieving actual search results for the second set of search parameters, and transmitting a second response comprising the actual search results. A corresponding computing system and a computer program are provided, too.

### CROSS REFERENCE TO RELATED APPLICATION

This application claims priority from European Application No. 25305244.3, filed Feb. 25, 2025, which is also incorporated herein by reference in its entirety.

### FIELD

The present disclosure relates to data processing and, in particular, to efficient data exploration for search requests.

### BACKGROUND

In nowadays systems, data requests and specifically those that do not define all characteristics of the requested data but relate to (at least partially not-defined) search tasks, often require data retrieval from multiple sources to obtain the data requested. Therefore, data retrieval usually is highly resource and time consuming. To improve the efficiency of data retrieval, a part of the data to be retrieved can be stored in a cache. A cache is a high-speed data storage layer that temporarily stores frequently used data, allowing for faster access to that data. It is useful because it reduces the time needed to access data by reducing the need to access the underlying primary and original but significantly slower storage layer

However, storing and retrieving data from caches (replacing or in addition to data retrieval from original sources) still requires a non-neglectable amount of processing and storage resources. Moreover, caching also requires to retrieve original data from original sources if the cache entries are not up-to-date. This means, the more requests a client transmits to a data retrieval system, the more requests have to be processed—be it by retrieving the data from the original data source or the cache.

Therefore, there is still a need to further develop new data retrieval principles that improve the efficiency of data retrieval for clients.

### SUMMARY

In this context, according to a first aspect, a computer-implemented method for processing data requests is presented. The method comprising receiving, from a client, a first request defining a first set of search parameters, wherein the first set of search parameters defines a first search space, predicting, using a search model, search results to requests for different sets of search parameters within the first search space, determining one or more sets of search parameters from the different sets of search parameters associated with predicted search results, wherein the one or more determined sets of search parameters define a search space smaller than the first search space, transmitting, to the client, a first response comprising at least a part of the one or more determined sets of search parameters with one or more associated predicted search results, receiving, from the client, a selection of a second set of search parameters, wherein the second set of search parameters corresponds to at least one of the one or more determined sets of search parameters, retrieving, by applying one or more search engines, actual search results for the second set of search parameters, and transmitting, to the client, a second response comprising the actual search results.

In embodiments, the search model is trained on historical data stored in one or more databases. In further embodiments, the search model is a machine learning model performing a regression or classification task.

In embodiments, predicting the search results and/or determining the one or more sets of the search parameters is based on preferences of the client and/or a user associated with the first request. In further embodiments, determining the one or more sets of the search parameters is further based on historical behaviour of the client and/or the user associated with the first request.

In embodiments, predicting the search results and determining the one or more set of the search parameters are executed locally at a client device, on which the client is located, and/or at a processing system in the cloud. In some embodiments, further comprising retrieving, by applying the one or more search engines, initial first search results for a restricted set of search parameters within the first set of search parameters, wherein the first response further comprises the initial first search results.

In embodiments, receiving the first request, transmitting the first response, receiving the second request, and/or transmitting the second response is supported by an interactive user interface. In further embodiments, the interactive user interface comprises a chatbot. In some further embodiments, the interactive user interface further comprises several search fields indicating values and/or ranges of search parameters. In yet further embodiments, the values and/or ranges of search parameters reflect recommended search parameter value or ranges that lead to specific predicted outcomes of search result properties. In additional embodiments, the interactive user interface further indicates the specific predicted outcomes of search result properties.

In embodiments, determining the one or more sets of search parameters comprises determining at least one high-impact search parameter having a large impact on predicted outcomes of search result properties, and determining the one or more sets of search parameters based on the determined at least one high-impact search parameter, wherein the first response comprises an indication of the determined at least one high-impact search parameter.

According to a second aspect, a computing system for processing data request is presented that comprises at least one processor, and at least one memory storing instructions that, when executed by the at least one processor, cause the computing system to execute the methods described herein.

According to a third aspect, a computer program product is presented that stores instructions that, when executed by at least one processor, cause the at least one processor to execute the methods as described herein.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

The foregoing and further objects, features and advantages of the present subject matter will become apparent from the following description of exemplary embodiments with reference to the accompanying drawings, wherein like numerals are used to represent like elements, in which:

FIG. 1 is a flowchart illustrating a basic method according to the disclosure.

FIG. 2A shows a flow diagram of data retrieval as state of the art, whereas FIG. 2B illustrates the flow of data retrieval according to this disclosure.

FIG. 3 is an overview on components supporting data retrieval according to embodiments.

FIG. 4 presents a possible implementation with a local search optimizer.

FIG. 5 presents a possible implementation with distributed components.

FIG. 6A is an example of a user interface comprising several fields according to the disclosure, whereas FIG. 6B is an example of a user interface based on a chatbot field only.

FIG. 7 is a comprehensive implementation diagram according to a travel search related embodiment.

FIG. 8 shows an example conversation of a guided search in a travel context.

FIG. 9 is diagrammatic representation of internal components of a computing system, which may implement all or part of the functionalities described herein.

### DETAILED DESCRIPTION

The present disclosure relates to methods and systems for efficient data retrieval. In particular, methods, systems, and computer programs for data retrieval supported by predicting search results before submitting requests for actual search results are disclosed.

Data retrieval is a resource and time consuming tasks, in particular, in computing systems that are highly distributed and in which requests for data from a client require transmission of data requests to multiple sources to obtain the requested data. Examples of such data requests in computing systems range from web searches over requests for services and products in provider networks to data requests in general to multiple databases.

These data requests (herein also denoted as search requests) consume a significant amount of processing and network transmission resources. Caching is one solution to reduce this amount of resources. However, caching is also limited in terms of storage capacity and accuracy and often still requires the retrieval of original data. The herein presented solution presents an alternative or even additional approach to caching for improving the efficiency of data requests, which is based on predicting possible search results before actually retrieving data from caches and/or original sources.

The general solution presented herein explores data relating to partial or adjustable search information and aims at finding results that fit to the search requirements most before actually transmitting search requests to original sources. This overcomes the issues to perform search requests that have to be restrictive in their search scope to obtain results, requiring multiple search requests to cover a desired search range. Moreover, performing such multiple search requests further would be expensive and/or slow, whereas the presented solution only requires a limited number of actual search requests to find the most suitable results.

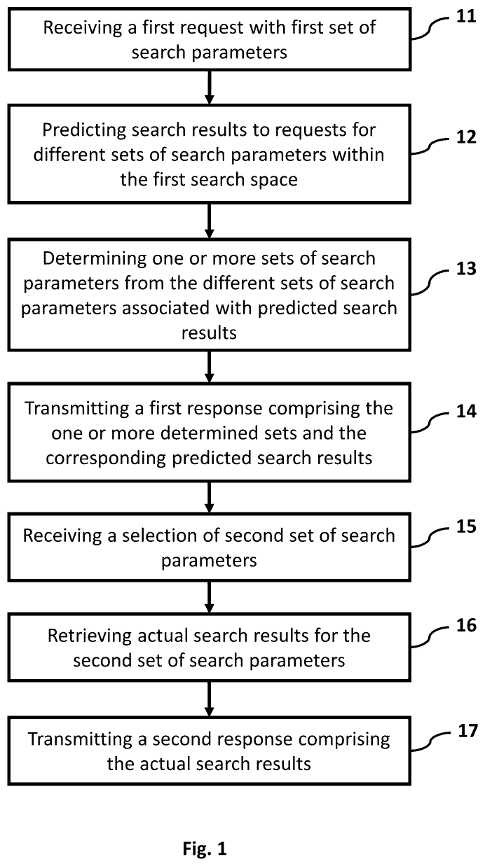

FIG. 1 is a flowchart illustrating a basic method according to the disclosure. The method starts in box 11 with receiving, from a client, a first request defining a first set of search parameters. A search parameter relates to a value or a range of a characteristic, which a retrieved search result can have. A set of search parameters, thus, relates to one or more fixed values or ranges of characteristics. A client in this disclosure is to be understood to be any software and/or hardware component interacting with a (host) search component.

The first set of search parameters defines a first search space. A search space is defined as all possible search parameter value combinations. This means, if no search parameters are given, the size of the search space reflects the number of (fully defined) searches needed to retrieve all possible search results. As a consequence, the search parameters defined in a search request limit the possible combinations and define a search space, which is smaller than the original search space of all possible combinations.

The size of a search space depends on its dimension and the possible value ranges within a dimension. For example, a search request issued by a client, e.g., an application, to find a server for providing software updates may, for having one single solution (i.e., one single search response), requires to define four search parameters, e.g., an update version, a date, a time, and a geographic region of the update server. This search space has a dimension of 4.

The update version value may be of a predetermined set, e.g., v0.5, v0.6, v0.7. The date values may not be limited and starting from today onwards (e.g., until the end of the month). The time value may be day or night and the geographic regions may be selectable as one of Africa, Asia, Central America, Europe, North America, South America, and Oceania. The size of a search space with no limitations is this example is already quite large (calculated by all permutation of search parameter values) and thousands of searches would be required to retrieve all possible search results.

Therefore, when a search request is transmitted, at least some search parameters are fixed. Hence, the application may define the needed update version as being version v0.7. The application may also define that it needs the update until the end of a week, i.e., submitting a range of 7 days. The application may also define that it requires the update to be at night and may be flexible in terms of the geographic region. In this example, the search space is significantly reduced and has a size of 49 (7 days times 7 regions—the further possible search parameters are all fixed), i.e., 49 searches, each of which may also require multiple data retrieval requests to multiple sources, are needed to retrieve all possible search results fulfilling the fixed search parameters.

The method proceeds in box 12 with predicting, using a search model, search results to requests for different sets of search parameters within the first search space. The search model may be any model that is capable of predicting search results. The search model can be considered as a simulation of a possible search, receiving as input a set of (fully defined) search parameters and outputting a likely outcome of such a search.

In some embodiments, the search model may be trained on historical data stored in one or more databases. Such historical data may comprise data of historical searches, historical characteristics and properties of the searched data (or items/services etc.), historical snapshots of caches holding search result data, and the like. In some further embodiments, the search model may be a machine learning model performing a regression or classification task for predicting search results. Additionally or alternatively, the search model may be a statistical model or a combination of different models. The search model may be updated continuously based on “new” historical searches to keep the model up-to-date.

The search model is applied on different sets of search parameters within the first search space. This means that modifications of search parameters which are still flexible, e.g., not defined to be a single value in the search request, are performed and the searches of resulting sets of search parameters are simulated. In some embodiments, all possible modifications or permutations of flexible search parameters may be generated and used as input for the search model. In some other embodiments, only some modifications may be simulated since other sets of search parameters may not be sensible or known to not produce results that are relevant for the client (e.g., because the client has indicated that results with specific properties will not be selected or are not of general relevance).

The search model may predict one or more properties of the search results provided in response to a set of search parameters but may not predict all properties of the search results. Properties of search results relate to information that usually is relevant for the client to decide on selection of search results and, which are usually not reflected in search parameters. However, in some embodiments, such predicted properties may also be reflected in search parameters. For example, considering again the update example. The search model may predict a (minimum/maximum) data rate that is likely to be achievable by a specific set of search parameters but may not predict, which specific server provides this service. In some embodiments, the prediction may be limited to one specific property, which is the information on which the client bases its decision(s). The data rate may not be a search parameter in some examples but may be, e.g., related to a search parameter (e.g., minimum data rate) in others.

The method proceeds in box 13 with determining one or more sets of search parameters from the different sets of search parameters associated with predicted search results. The one or more determined sets of search parameters define a search space smaller than the first search space. In other words, the first set of search parameters has less fixed values or larger ranges of search parameters than the one or more determined sets of search parameters. Thus, the number of searches required to retrieve all search results for the one or more determined sets of search parameters is smaller than the number of searches required to retrieve all results for the first set of search parameters. In box 14, the method then proceeds to transmitting, to the client, a first response comprising at least a part of the one or more determined sets of search parameters with one or more associated predicted search results.

In some embodiments, predicting the search results and/or determining the one or more sets of the search parameters may be further based on preferences of the client and/or a user associated with the first request. In some further embodiments, determining the one or more sets of the search parameters may further be based on historical behaviour of the client and/or the user associated with the first request. It is noted that historical behaviour also reflects preferences, namely, implicit preferences, whereas preferences of the client and/or user are explicit preferences.

Preferences of the client and/or or user may be defined before submitting the first search request. Preferences may comprise an indication of characteristics (relating to search parameters) or properties (relating to search results). Therefore, a client, e.g., the application as defined in the update example given before or a search client of one specific type etc., may define that it requires specific characteristics in search parameters or specific properties of the search results before transmitting a search request. Such preferences may also be stored in a client and/or user profile and apply for any search requests transmitted via the herein described system.

In the update example, the client may define that the client tends to not use an update server in Asia or Europe. This means, that this preference could already be considered for simulation, e.g., box 12, but may also only be considered later when determining the sets of search parameters. The latter option allows to nevertheless select a set of search parameters (and the predicted search results), which does not follow the preferences but may nevertheless provide a more beneficial search result (e.g., in terms of properties, which may be the deterministic aspects of a client or user selecting a search result).

Historical behaviour may be determined by the system described herein. It can be considered as a feedback loop of interacting with clients and/or users. For example, if a user searching for flights always selects a non-stop flight or selects flights from one specific airline, this may be stored as historical behaviour and then be defined as a client preference. Such information may be only taken into account after having predicted search results by the search model for determination of the sets of search parameters. This allows to present to the client predicted search results which do not follow the preferences explicitly indicated by the client but may nevertheless provide a more suitable properties of predicted search results.

In some embodiments, predicting (box 12) the search results and determining (box 13) the one or more sets of the search parameters are executed locally at a client device, on which the client is located. Since the search model is a lightweight prediction model that simulates searches and does not need to retrieve the data to any extent, the prediction and determination of predicted search results to transmit to the client can be done locally at the client device, e.g., supported by a search application with a search optimizer component. Alternatively, predicting (box 12) the search results and determining (box 13) the one or more sets of the search parameters are executed at a processing system in the cloud. In some other embodiments, the prediction (box 12) may be performed in the cloud and the determination (box 13) may be performed locally. This said, the prediction generally pertains to an offline process meaning no data transfer to/from original sources (e.g., provider databases etc.) and caches is required.

In some embodiments, the first response may also comprise initial search results. Hence, the method may further comprise retrieving, by applying one or more search engines, initial first search results for a restricted set of search parameters within the first set of search parameters. The first response further may then comprise the initial first search results. In the update example given above, the application may indicate the next week as week for providing the update. An initial search may be restricted to tomorrow and even a specific region in order to provide initial search results, which do not require much search effort (since the search parameter are fixed to specific values). In parallel, the optimization of the search with the search model may take place, such that the first response provides actual initial search results and the prediction, which possible further (also limited) search requests may be sensible.

In some embodiments, determining the one or more sets of search parameters may further comprise determining at least one high-impact search parameter having a large impact on predicted outcomes of search result properties and determining the one or more sets of search parameters based on the determined at least one high-impact search parameter. In these embodiments, the first response may comprise an indication of the determined at least one high-impact search parameter.

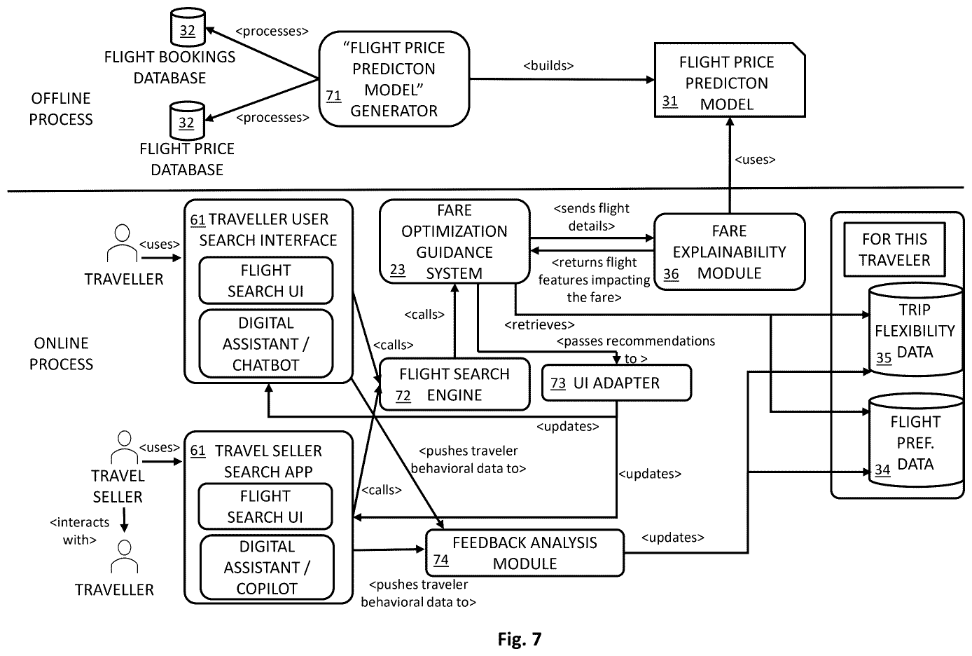

For example, when having simulated search results according to the different sets of search parameters with the search model, high-impact search parameters may be determined, e.g., by an SHAP algorithm as explained with respect to FIG. 7 or any other suitable algorithm for determining feature relevance (also denoted as feature contribution, feature explanation, or ranking of feature importance) of machine learning models. Based on these high-impact search parameters, one or more sets of search parameters may be determined, e.g., that define ranges of search parameters, which likely lead to optimized search result outcomes for the client. This determination may, in some embodiments, be based on determining derivates of search result properties and a counterfactual analysis of the resulting points, in order to further simulate search outcomes. The impact of the features, i.e., the search parameters on the (predicted) search results will be returned to the client, such that the client will be enabled to assess, which search parameters to modify/use etc. for a tailored search.

The method proceeds in box 15 to receiving, from the client, a selection of a second set of search parameters. The second set of search parameters corresponds to at least one of the one or more determined sets of search parameters. Hence, the client (or the user via the client) selects one or more of the determined and presented sets of search parameters for performing a “real” search for actual search results via one or more search engines.

Hence, the method then moves in box 16 to retrieving, by applying one or more search engines, actual search results for the second set of search parameters. This process may comprise transmitting search requests to meta search engines, applying a local search engine for directly assessing databases, and/or applying multiple search engines, e.g., search engines dedicated to specific data providers. In some embodiments, retrieving the actual search results comprises at least in part retrieving actual search results from a cache storage.

Finally, the method ends in box 17 with transmitting, to the client, a second response comprising the actual search results. Hence, the client is then provided with such actual search results, which were predicted to have the most suitable properties for the client. Therefore, the client does not need to transmit multiple different search requests to retrieve the required data and/or transmit a widely unrestricted search request, which would require multiple (hundreds, thousands, and even much more) searches for retrieving data.

As is apparent, the herein presented data retrieval system with the prediction based on a search model improves the efficiency of almost any search (if at least some search parameters provide flexibility) but is specifically advantageous for distributed search tasks, which allow searching for a large number of search parameters and require searches in multiple original sources. Since the latter search tasks are often initiated by users (e.g., searches for produces and services via the Internet or the like), the processes of receiving the first request, transmitting the first response, receiving the second request, and/or transmitting the second response may be supported by an interactive user interface presented to a user.

In some embodiments, the interactive user interface may comprise a chatbot (or a human agent or any type of interactive communication tool that can provide feedback and suggestions during a search session). The chatbot may support entering the first search request in natural language and/or prompting suggested changes/values/ranges of search parameters (based on the prediction). The interactive user interface may further comprise several search fields indicating values and/or ranges of search parameters. In these search fields, the user may input the search parameters (values and/or ranges). The search fields may also be prefilled after receiving the first response with recommended values and/or ranges. Hence, the values and/or ranges of search parameters may reflect recommended search parameter value or ranges that lead to specific predicted outcomes of search result properties. The specific predicted outcomes of search results may also be shown on the interactive user interface.

In some embodiments, the chatbot may provide further explanations of the recommended values and/or ranges of search parameters. For example, the chatbot may provide explanations that the recommended search parameters lead to the most beneficial search result outcome. In some embodiments, the interactive user interface may further indicate the specific predicted outcomes of search result properties.

In a specific example of a user searching for flights, the user may have merely indicated (as first request) that she wants to travel from Munich to Paris in May for one week without indicating a particular date or time period for the travel. As may be known or indicated by the user, the most relevant property of the search results is the flight price, i.e., the cheaper, the better. The prediction may then indicate that—in terms of price—the best week is the second week of May. Also, the prediction may indicate that flying on Tuesdays is the cheapest. Hence, the chatbot may indicate to the user that this is a likely outcome of a search and suggests to use these search parameters. The chatbot may also indicate that this may lead to a price of 300 Euro, whereas the first week of May may lead to a price of 350 Euro and the last two weeks will have prices over 400 Euro. Hence, the user can make an educated decision of search parameters and only submit such search parameters for retrieving actual search results that are relevant for the user. The system described herein therefore provides a pre-search supported by a simulation of search result properties to tailor the search requests transmitted to retrieve actual search results.

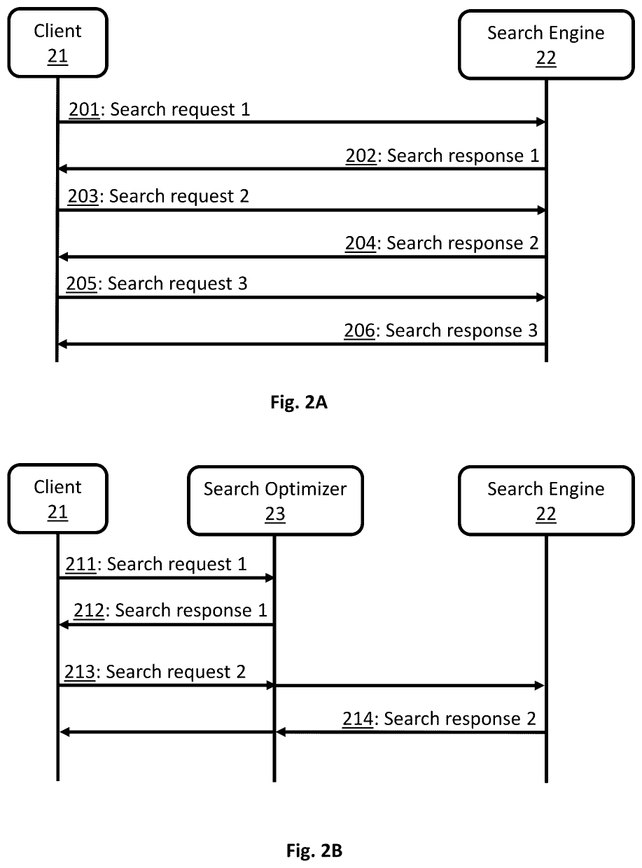

To further highlight the improvements provided by the herein presented systems for data retrieval, FIG. 2A shows a flow diagram of data retrieval as state of the art. A client 21 transmits a search request 201 to a search engine 22. For example, the search request 201 may comprise a set of search parameters, which lead to the search response 202. The client 21 may be flexible and trying to find a search result with an optimized property, e.g., a minimized price, a highest data rate, etc. or combinations thereof. Such optimized search result may or may not be included in the search response 202. However, since the client 21 does not know the optimized search result, the client 21 will transmit another search request 203 to the search engine 22, which will be answered with search response 204. This may happen multiple times (e.g., as shown with search request 205 and search response 206) until the client 21 is satisfied with the search results or has explored the search space (defined by its flexibility).

For example, a user associated with the client 21 (e.g., a user who connects via the client 21 with the search engine 22) may search for flights. A first search may be directed to flights from Munich to Paris on the 10^{th} of December, which returns a minimum price of 350 Euro. A second search may be directed to flights on the 11^{th} of December. A third search may be directed to flights on 9^{th} of December. A fourth search may be directed to flights from Nuremberg to Paris on the 10^{th} of December and so on. When having received all search results, the user may select the flight with the best properties, e.g., price, number of stops, time of the day, and the like. Retrieving the search results, however, requires many searches in original sources, queries on websites and databases, retrieval from cache storages, and the like. The same is true for any other client 21, e.g., applications for network management, routing components, and the like, which transmit searches that are not limited in many search parameters. In such cases, only one search request may be transmitted to the search engine 22 but the search engine 22 itself will transmit multiple search request to original sources and/or perform multiple searches to retrieve all search results fulfilling the search space. Hence, this type of searching consumes significant technical resources such as network resources and response time, and is therefore not efficient.

FIG. 2B now illustrates the flow of data retrieval according to this disclosure. The client 21 transmits a first search request 211 to a search optimizer 23. It is noted that the search optimizer 23 may also appear as a search engine to the client 21 or may be included in or comprise the search engine 22. As mentioned above, the search optimizer may also be co-located with the client 21, i.e. may be arranged on the same device (e.g. smartphone) as the client 21. The search optimizer 23 performs (hundreds, thousands of) simulations thanks to a search model simulating search results for different sets of search parameters. The client 21 then receives a first search response 212, which comprises the search parameters with predictions of search outcomes of at least some of the different sets of search parameters.

This first search response 212 enables the client 21 to define and transmit a second search request 213, which is directed to search parameter values or ranges indicated in the first search response 212 restricting the search processes at the search engine 22 to a smaller search space and thus limiting technical resources to be spent for actual traditional search processes (such as database retrieval, cache retrieval, dynamic fare calculation, etc.). Hence, the methods of predicting search results at a pre-search stage as described herein are capable of limiting searches to one (narrower, more restricted) actual search requests.

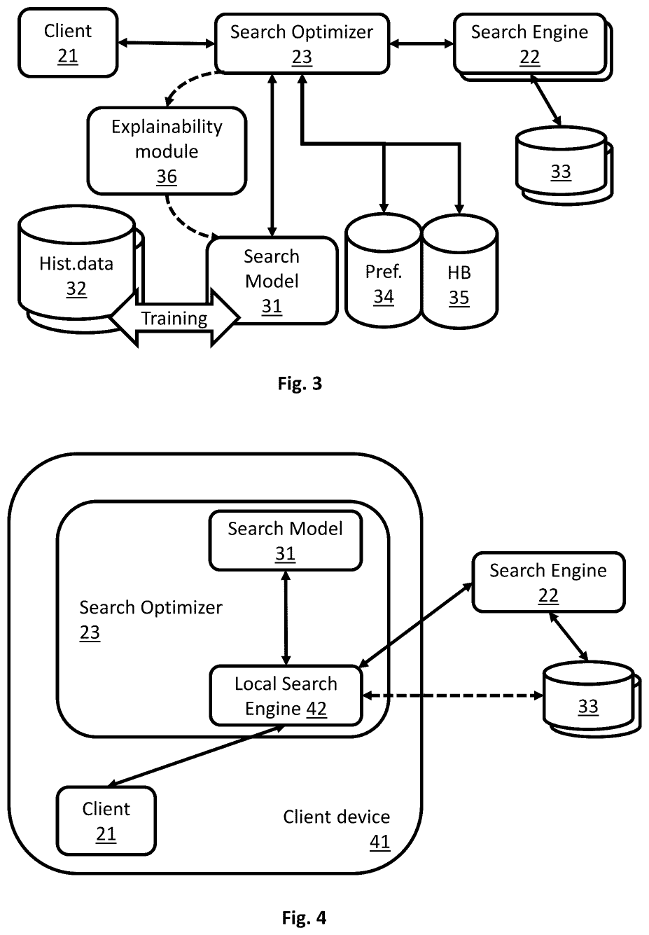

FIG. 3 is an overview of components supporting data retrieval according to embodiments. A client 21 is connected to a search optimizer 23. The client 21 transmits search requests to the search optimizer 23. Hence, the search optimizer 23 may provide an interface to the client 21, which allows to transmit search parameters in order to retrieve search results. The search optimizer 23 utilizes a search model 31 for predicting search results, e.g., as explained above with respect to FIG. 1. The search model 31 may be trained on historical data 32, which may be stored in one or more storage systems, e.g., databases. In such embodiments, the search model 31 may be a machine learning model, which is trained to predict/estimate properties of search responses to sets of search parameters. Hence, the historical data 32, which is used for training, comprises information on historical searches and properties of search results. The search model 31 may be trained to, e.g., perform a regression or classification task on search parameter input. Commonly known machine learning models can be applied for the search model 31. Alternatively, statistical models can be used to simulate search responses.

The search optimizer 23 then presents at least some of simulated search results (or the respective properties) and the corresponding search parameter values/ranges to the client 21. The determination which search results and corresponding search parameters are presented to the client 21 may be, in some embodiments, based on preferences 34 or historical behaviour data 35 of the client 21 as has been explained above. The preferences 34 and historical behaviour data 35 may be retrieved from databases as is shown in FIG. 3. Alternatively, the preferences 34 may also be provided with the search requests from the client 21. The historical behaviour data 35 may be obtained by a feedback look, i.e., taking into account which selection of search results and/or which search parameter modifications the client 21 made.

For retrieving actual search results, the search optimizer 23 may be connected to one or more search engines 22, which then retrieve the actual search results from original data sources 33 or from a cache storage. The search engines 22 and the original data sources 33 may not form part of the herein described solution, although the search optimizer 23 may also be located at the search engine 22 or form a functional part of the search engine 22. Search requests to search engines 22 may be transmitted as currently known in the art, however, as explained above with respect to FIGS. 2A and 2B, more limited search requests and/or a lesser number. One or more of the search engines 22 may also form a part of the solution described herein, e.g., if the search optimizer also includes or is included in a search engine.

In some embodiments, the application of the search model 31 by the search optimizer 23 may also invoke an application of an explainability module 36. The explainability module 36 may be a part of the search optimizer 23 or a separate module. The explainability module 36 may determine at least one high-impact search parameter having a large impact on predicted outcomes of search result properties. The one or more sets of search parameters may then be based on the determined at least one high-impact search parameter. Therefore, first response may comprise an indication of the determined at least one high-impact search parameter.

FIG. 4 presents a possible implementation with a local search optimizer, e.g., a search optimizer 23 with the client 21 being provided as an application on a client device 41. The search optimizer 23 thereby represents an improved search application and comprises the search model 31 (i.e., a local copy of a search model as described herein, which predicts search outcomes and which may be updated from time to time from a server). The search optimizer 23 may also comprise a local search engine 42, which may be a lightweight search engine interface or application part, which is capable of receiving search requests from the client 21 and retrieves predicted search results from the search model 31 as well as actual search results from original data sources 33. For retrieving actual search results from original data sources 33, further search engines 22, e.g., those of content providers and the like, may be used.

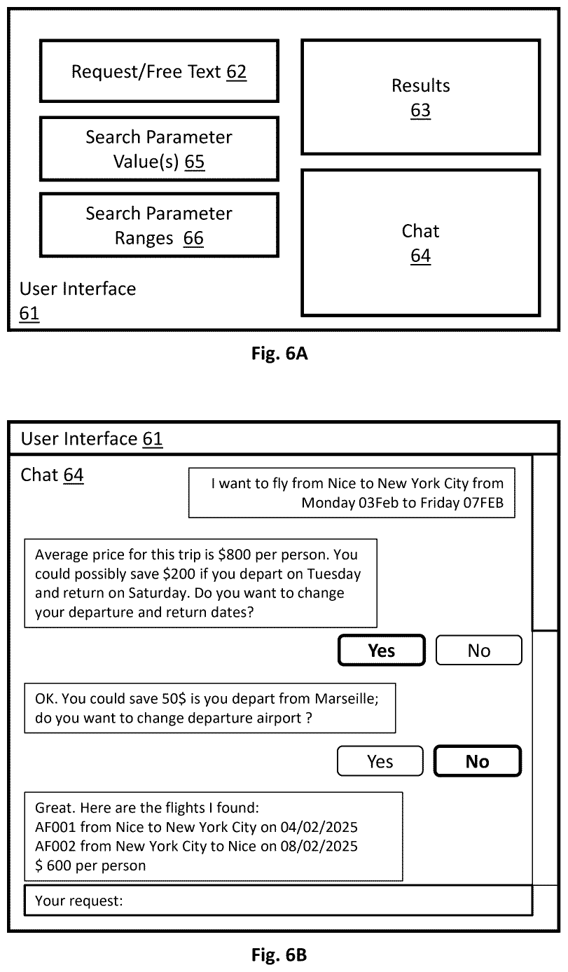

The application on the client device 41 may provide a user of the client device 41 with an interactive user interface, for example, a user interface as shown with FIG. 6A or FIG. 6B, which may serve as client 21 for transmitting the search parameters. The user may be guided through the definition of search parameters by the user interface, e.g., by a chatbot, which uses the predictions of the search model 31. For example, the chatbot may provide the user with recommendations of search parameters to optimize properties of search results.

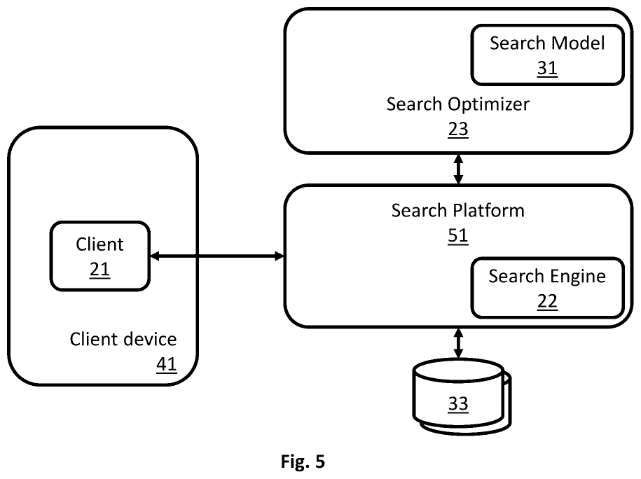

FIG. 5 presents a possible implementation with distributed components. The client device 41 only comprises the client 21 (e.g. a lightweight application providing a user interface or a web client for connecting to a search platform 51). The search platform may comprise or interface with the search optimizer 23, which comprises or interfaces the search model 31. The search platform 51 may also comprise one or more search engines 22 (or interface with one or more separate search engines 22) to retrieve the actual search results 33. The search optimizer 23 and the search model 31 may be located in the cloud and utilized by the search platform 51.

As is apparent from the description, different architectures are possible for achieving the improvements of the herein described data retrieval solution. The search model 31 may be run in one single location, be it locally or in the cloud, and does not need to have access to actual search result data. In contrast, using the search engines 22 in the common way requires multiple distributed components for providing the client 12 with search results.

FIG. 6A is an example of a user interface 61 according to the disclosure. It is noted that not all components shown in FIG. 6A may be present in a user interface and only some elements may be provided. Moreover, the arrangement of elements is only of an illustrative nature and should not be considered to be limiting.

The user interface 61 may be an interactive user interface as described above and support a user in finding the optimal search parameters before transmitting a search request for actual search results. The user interface 61 may comprise an input area 62 for inputting the search request in the form of search parameters or a free text input area. The search results may be provided in a result area 63. The search results may be ordered. Only some search results may be provided in the result area 63 and others may be accessible by scrolling. The result area 63 may also provide predicted results or a summary of predicted result properties alongside with recommended search parameters.

Alternatively or additionally, the user interface 61 may comprise a chat area 64. The chat area may also comprise the information alternatively or in addition provided in the input area 62 and the result area 63, i.e., no additional areas besides the chat area 64 may be provided. The chat area 64 may provide natural language text to the user explaining predictions of search results and recommendations of search parameters. This chat area 64 may be controlled by a chatbot, a human agent, or any type of interactive communication tool.

Alternatively or additionally, the user interface 61 may comprise one or more value areas 65 and/or range areas 66, in which the user can input values and/or ranges for search parameters. In some embodiments, for each possible search parameter a value area 65 and/or a range area 66 is provided. Moreover, these areas 65, 66 may also be prefilled with recommendations based on prediction of the search model and the determination of the sets of search parameters to present to the user. This (e.g., why these values/ranges are recommended) may, in some embodiments, explained by in the chat area 64 to guide the user through a search.

FIG. 6B in another example of the user interface 61, which in this example is based on a chatbot field or chat area 64 only. Hence, the input area 62, the result area 63, the value area 65, and the range area 66 are implicitly provided in the chat area 64, which enables free text provision of search parameters, values and/or rages as well as showing the results.

In this example, a user wants to fly from Nice to New York from 3 February to 7 February. In this example, it is assumed that the user generally showed some flexibility in the past, e.g., because the user searches for different dates/departure cities. Hence, the herein presented system may, start with simulating the search results for the given search parameters but may also simulate search results for some days before and after and/or other cities.

That's why the chat bot indicates that the trip would be $800 per person but could be $200 cheaper if a change in date takes place. The user acknowledges the change. Afterwards, the chat bot also (still based on simulations, possibly run in the background while already providing some suggestions) indicates that another $50 can be saved if the departure airport is changed to Marseille. This suggestion is declined by the user. Hence, the only actual search is performed for a trip from Nice to New York on 4 February to 8 February. The results are then also shown in the chat are 64.

FIG. 7 provides a comprehensive implementation diagram according to a travel search related embodiment. The advantages of the herein presented solution are particularly apparent in this example. If a traveller is flexible with origins, destinations or both, the searches for flights are intractable today. Origins and destinations have many combinations (e.g., over 1 million).

It is noted that the shown functions and components as well as the described implementation aspects for FIG. 7 are not limited to the travel related embodiments and may be applied in a similar manner to different data retrieval embodiments as is apparent to the skilled person. Moreover, numerals in FIG. 7 indicate which components relate to which components described above although the names of the components may differ.

The general overview of FIG. 7 separates the processes in an online part and an offline part. Starting with the offline part, which relates to the generation of a flight price prediction model, corresponding to the search model 31. As can be seen, two databases hold the historical data 32, a flight bookings database and a flight price database. A flight price prediction model generator 71 performs the training based on the historical data 32 and builds the flight price prediction model 31. This model is stored and can be used by the online process.

The online part relates to processes of the actual search scenario. In the example of flight search, either the traveller or a travel seller for the traveller may be presented with a user interface, e.g., similar to the user interface 61. The user interfaces 61 may differ for both users as is shown in FIG. 7. However, both comprise a flight search user interface (part) and a digital assistant (part, e.g., chatbot, copilot etc.). Generally, the processes initiated via both user interfaces 61 are almost identical. Therefore, the description now focuses on the traveller with the traveller user search interface.

The traveller uses the user interface 61 for inputting an initial set of search parameters, possibly only a coarse idea of a flight she wants to book. A flight search engine 72 is called, which corresponds, e.g., to the search platform 51 (with one of the search engines 22) or the local search engine 42 as described above. Instead of sending now requests to multiple providers of flights, querying flight databases, or calling other external search engines for retrieving flights for the initial set of search parameters, the flight search engine 72 calls a fare optimization guidance system 23. The fare optimization guidance system 23 retrieves historical behaviour 35 (trip flexibility data) and preferences 34 (flight preference data) associated with the traveller. These data 34, 35 may be linked to a user profile of the traveller, i.e., the data 34, 35 can be retrieved by a user identifier or the like.

The fare optimization guidance system 23 then sends the flight details, e.g., the initial set of search parameters as provided by the traveller or the initial set of search parameters modified by, e.g., preference data 34, to a fare explainability module 36. The search optimizer 23 and the explainability module 36 as described above may correspond to the fare optimization guidance system 23 and the fare explainability module 36.

The fare explainability module 36 may pre-process the information received from the fare optimization guidance system 23, e.g., to limit the search space to be explored by the flight price prediction model 31. Moreover, the fare explainability module 36 may use a Shapley Additive Explanations (SHAP) algorithm, which is a game theoretic approach to explain the output of any machine learning model. For non-linear black box models, e.g., machine learning model, SHAP provides accurate and consistent feature importance values. It allows meaningful, local explanations of individual predictions. SHAP borrows concepts from cooperative game theory, namely, the Shapley Values

Shapley values are a concept in cooperative game theory. They were introduced in 1953 by the Nobel Prize winner Lloyd Shapley. The overall intuition behind the concept is that sometimes a player value in a team could be greater than their value if they were on their own. In a machine learning setting a Shapley value is the contribution of a feature value to the difference between the actual prediction and the mean prediction, which is equivalent to answering this question: “Given that without any features we would just predict an average value, once we bring the first feature in, how much does our prediction changes compared to the average?”

Therefore, the use of an SHAP algorithm on the predicted search results allows the fare explainability module 36 to explain which search parameters, e.g., destination, origin, time to departure, day of the week, etc., have the most impact on properties of search results, e.g., the fare, and also provide this explanation to the traveller.

The fare optimization guidance system 23 then receives the identified features and the predicted search results, e.g., a model of the flight price. Based thereon, one or more sets of search parameters, e.g., one or more feature value spaces, for an optimal, e.g., minimal flight price are determined. An example algorithm for this (Algorithm 1) is shown in the following:

```
Algorithm 1:
Algorithm 1 Fare optimization guidance algorithm
  1: Input: Model Price predicting the flight prices, features Xᵢ identified by
    the Fare explainability module
  2: Output: Range of feature values around minimum points for optimal price
  3: procedure IDENTIFYOPTIMALFEATURESPACE
  4: for each continuous feature Xᵢ do
  5:  $Compute first derivative \frac{\partial Price}{\partial {X}_{i}}$
  6:  $Compute first derivative \frac{{\partial }^{2} Price}{\partial {X}_{i}^{2}}$
  7:  $if \frac{{\partial }^{2} Price}{\partial {X}_{i}^{2}} > 0 and \frac{\partial Price}{\partial {X}_{i}} = 0 then$
  8: Define a small neighborhood around Xᵢ
  9: Perform counterfactual analysis within this neighborhood
  10: Determine the feature value space for optimal price
  11: end if
  12: end for
  13: end procedure
```

The determined sets of search parameters, which reflect recommendations, are then transferred to a UI adapter 73, which updates the user interface 61 accordingly. Moreover, the behaviour (e.g., selection of search parameters, selection of search results etc.) of the traveller is pushed by the user interface 61 to a feedback analysis module 74, which then updates the preference data 34 and/or behavioural data 35.

In summary, the processes of FIG. 7 assist travellers in discovering the optimal travel solution that aligns with their preferences. The solution offers clear and comprehensible explanations for travel suggestions, provides users with the opportunity to investigate “what if” scenarios, helping them comprehend how various decisions affect their travel arrangements, and can be highly customized, taking into account individual preferences and constraints to enhance travel solutions. Finally, the feedback loop helps to identify the characteristics that shape the profiles of users in order to provide optimized search results to travellers.

In particular, the herein presented solutions may provide guidance for searches with explainability analysis of the prediction provided by the search model 23. Search result properties, e.g., fares, may be simulated before launching an actual search, which reduces the total number of searches related to a search tasks in general. Moreover, capturing information about preferences and behaviour further guides the searches to reduce the overall needed actual search tasks, i.e., reducing energy consumption and CO2 emission.

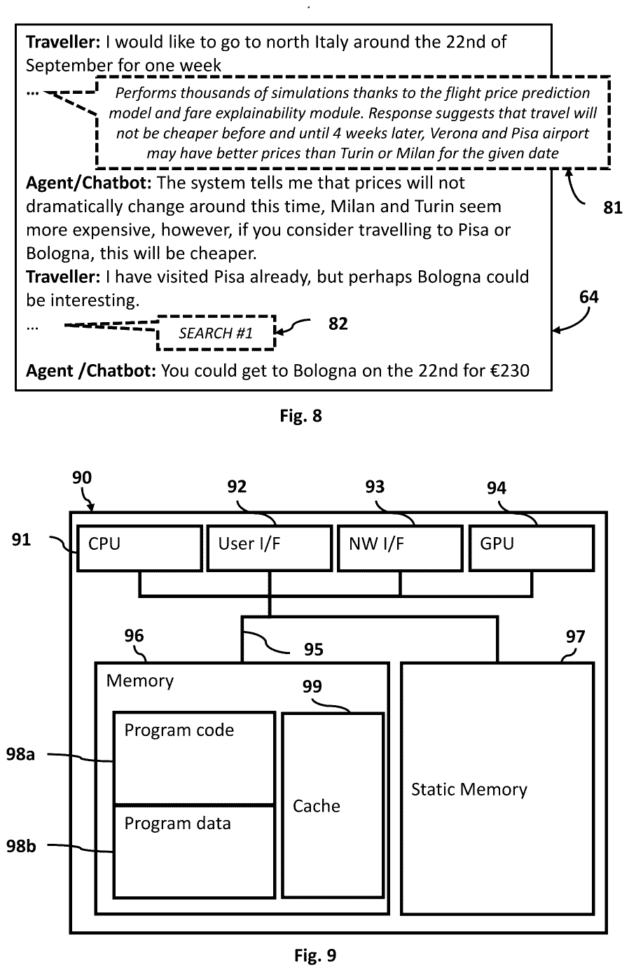

FIG. 8 shows an example conversation of a guided search in a travel context, which may, e.g., be supported by a chatbot, a human assistant, a text-based communication algorithm, or the like. This conversion of FIG. 8 may take place in the chat area 64 (as described with respect to FIG. 6A or FIG. 6B) of the user interface 61.

In this example, a traveller indicates that she would like to go to the north of Italy on the 22^{nd} of September for one week. The underlying system may be aware of preferences and historical behaviour of the user and/or may have further information stored in a user account. From this information, the system may know that the traveller lives in Madrid, which serves as the origin for this flight search. However, the north of Italy is still a wide area and at least four destination cities fulfil this request, namely, Milan, Pisa, Turin, and Verona. Furthermore, the traveller also seems to be also slightly flexible with respect to the travel date.

In a conventional search system, this request would lead to at least four searches for each of the cities (each search being itself composed of queries to multiple providers and databases) and possibly many more searches for possible travel dates around the 22^{nd} of September. The herein presented solution, in contrast, first simulates, with the help of the search model 31 (in this example, the flight price prediction model 31 of FIG. 8) possible search outcomes for different sets of search parameters, i.e., combinations of any of the four cities with different dates around the 22^{nd} of September. Moreover, with the help of the fare explainability module 36 of FIG. 8, the chat can also indicate why which search parameters are suggested and impact the flight price. These processes are depicted in balloon 81.

The response then indicates that prices will not dramatically change around the given date of 22^{nd} of September. Moreover, it is also indicated that Milan and Turin are more expensive but Pisa or Bologna are cheaper. Hence, the traveller confirms that Bologna is a good destination. Only then, the first search (as shown with balloon 82) is performed for actual search results. This is a very tailored and quick search and likely only requires a few search queries to flight providers or queries in flight databases. In this example, the guided search is a behind the scenes assistant, based on artificial intelligence, which evaluates how a fare could be cheaper based on explainable artificial intelligence, which simulates alternatives using, e.g., counterfactual analysis in order to suggest an optimal search (or recommendations for an optimal search).

The following table 1 illustrates the advantages of the current solution compared to retrieving search results from original sources and from (an additional) cache:

TABLE 1

| Retrieval | | Search Space/ | Computation |
|---|---|---|---|
| from | Characteristics | Coverage | location |
| Search | Large response time | All search results | Cloud |
| Engine | Usually provides limited | only cover a | Requires calls to |
| | recommendations | small area of the | multiple |
| | Often thousands of | search space, i.e., | independent |
| | parameters to tune results | many searches | providers and/or |
| | Relies on multiple calls to | necessary | databases (for |
| | different subcomponents | | travel example, |
| | over a network (for travel | | e.g., route |
| | example, including but not | | scoring, |
| | limited to: itinerary builder, | | availability, |
| | availability checker, price | | pricing) |
| | computation etc.) | | |
| Cache | Most frequent searches are | The cache does | Cloud |
| | placed in a cache to speed | not cover all | Calls may still |
| | up responses and reduce costs | items and needs | be required |
| | Still often a need to update | to be refreshed | |
| | results by using the search | | |
| | engine | | |
| Offline | A machine learning model | The search space | Cloud or on the |
| prediction | is trained to predict search | can be very large | edge (a client |
| | result properties based on | and explored | device) - in any |
| | large volumes of data (for | efficiently, and | case, offline |
| | travel example, e.g., the | thanks to | prediction |
| | content of the inventory, or | explainable AI | without any calls |
| | cache or historical fares) | techniques, this | required |
| | Prediction of thousands of | can be guided | |
| | search results (i.e., at least | and constrained | |
| | some properties thereof) | based on traveler | |
| | for a diverse set of features | needs at no | |
| | in under a second | additional cost. | |

FIG. 9 is a diagrammatic representation of internal components of a computing system 90 implementing the functionality of one or more of the components as described herein. The computing system 90 includes at least one processor 91, a user interface 92, a network interface 93, and a main memory 96, that communicate with each other via a bus 95. Optionally, the computing system 90 may further include a static memory 97 and a disk-drive unit (not shown) that also communicate with each via the bus 95. A video display, an alpha-numeric input device and a cursor control device may be provided as examples of user interface 92. Furthermore, the computing system 90 may also comprise one or more graphics processing units (GPU) 94.

The GPUs 94 may also comprise a plurality of GPU cores or streaming multiprocessors, which comprise many different components, such as at least one register, at least one cache and/or shared memory, and a plurality of ALUs, FPUs, tensor processing unit (TPU) or tensor cores, and/or other optional processing units. GPUs can perform multiple simultaneous computations, thereby enabling the distributing of training processes and speeding up machine learning operations.

The main memory 96 may be a random-access memory (RAM) and/or any further volatile memory. The main memory 96 may store program code 98a and may also store additional program data 98b required for providing part or all of the functionalities described herein. Moreover, the main memory 96 may also include a cache 99.

According to another aspect, a computer program comprising instructions may be provided. These instructions, when the program is executed by a computer, cause the computer to carry out the methods described herein. The program code embodied in any of the systems described herein is capable of being individually or collectively distributed as a program product in a variety of different forms. In particular, the program code may be distributed using a computer readable storage medium having computer readable program instructions thereon for causing a processor to carry out aspects of the embodiments described herein.

Computer readable storage media, which are inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer.

A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

It should be appreciated that while particular embodiments and variations have been described herein, further modifications and alternatives will be apparent to persons skilled in the relevant arts. In particular, the examples are offered by way of illustrating the principles, and to provide a number of specific methods and arrangements for putting those principles into effect.

In certain embodiments, the functions and/or acts specified in the flowcharts, sequence diagrams, and/or block diagrams may be re-ordered, processed serially, and/or processed concurrently without departing from the scope of the disclosure. Moreover, any of the flowcharts, sequence diagrams, and/or block diagrams may include more or fewer blocks than those illustrated consistent with embodiments of the disclosure.

The terminology used herein is for the purpose of describing particular embodiments only and is not intended to be limiting of the embodiments of the disclosure. It will be further understood that the terms “comprise” and/or “comprising,” when used in this specification, specify the presence of stated features, integers, processes, operations, elements, and/or components, but do not preclude the presence or addition of one or more other features, integers, processes, operations, elements, components, and/or groups thereof. Furthermore, to the extent that the terms “include”, “having”, “has”, “with”, “comprised of”, or variants thereof are used in either the detailed description or the claims, such terms are intended to be inclusive in a manner similar to the term “comprising”.

While a description of various embodiments has illustrated the method and while these embodiments have been described in considerable detail, it is not the intention of the applicants to restrict or in any way limit the scope of the appended claims to such detail. Additional advantages and modifications will readily appear to those skilled in the art. The disclosure in its broader aspects is therefore not limited to the specific details, representative apparatus and method, and illustrative examples shown and described. Accordingly, the described embodiments should be understood as being provided by way of example, for the purpose of teaching the general features and principles, but should not be understood as limiting the scope, which is as defined in the appended claims.

1. A computer-implemented method for processing data requests, comprising:
receiving, from a client, a first request defining a first set of search parameters, wherein the first set of search parameters defines a first search space;
predicting, using a search model, search results to requests for different sets of search parameters within the first search space;
determining one or more sets of search parameters from the different sets of search parameters associated with predicted search results, wherein the one or more determined sets of search parameters define a search space smaller than the first search space;
transmitting, to the client, a first response comprising at least a part of the one or more determined sets of search parameters with one or more associated predicted search results;
receiving, from the client, a selection of a second set of search parameters, wherein the second set of search parameters corresponds to at least one of the one or more determined sets of search parameters;
retrieving, by applying one or more search engines, actual search results for the second set of search parameters; and
transmitting, to the client, a second response comprising the actual search results.

2. The method of claim 1, wherein the search model is trained on historical data stored in one or more databases.

3. The method of claim 2, wherein the search model is a machine learning model performing a regression or classification task.

4. The method of claim 1, wherein predicting the search results and/or determining the one or more sets of the search parameters is based on preferences of the client and/or a user associated with the first request.

5. The method of claim 4, wherein determining the one or more sets of the search parameters is further based on historical behaviour of the client and/or the user associated with the first request.

6. The method of claim 1, wherein predicting the search results and determining the one or more set of the search parameters are executed locally at a client device, on which the client is located, and/or at a processing system in the cloud.

7. The method of claim 1 further comprising retrieving, by applying the one or more search engines, initial first search results for a restricted set of search parameters within the first set of search parameters, wherein the first response further comprises the initial first search results.

8. The method of claim 1, wherein receiving the first request, transmitting the first response, receiving the second request, and/or transmitting the second response is supported by an interactive user interface.

9. The method of claim 8, wherein the interactive user interface comprises a chatbot.

10. The method of claim 8, wherein the interactive user interface further comprises several search fields indicating values and/or ranges of search parameters.

11. The method of claim 10, wherein the values and/or ranges of search parameters reflect recommended search parameter value or ranges that lead to specific predicted outcomes of search result properties.

12. The method of claim 11, wherein the interactive user interface further indicates the specific predicted outcomes of search result properties.

13. The method of claim 1, wherein determining the one or more sets of search parameters comprises:
determining at least one high-impact search parameter having a large impact on predicted outcomes of search result properties; and
determining the one or more sets of search parameters based on the determined at least one high-impact search parameter;
wherein the first response comprises an indication of the determined at least one high-impact search parameter.

14. A computing system for processing data requests comprising:
at least one processor; and
at least one memory storing instructions that, when executed by the at least one processor, cause the computing system to execute the method of claim 1.

15. A computer program product storing instructions that, when executed by least one processor, cause the at least one processor to execute the method of claim 1.
